(19) United States
(12) Patent Application Publication
(10) Pub. No.: US 2026/0002623 A1
(43) Pub. Date: Jan. 1, 2026

(54) REPAIR CLAMP

(71) Applicant: Mueller International, LLC, Atlanta, GA (US)

(72) Inventors: David Latimore Hughes, JR., Signal Mountain, TN (US); Timothy Wayne Stern, Hixon, TN (US); Alice Meredith Byrnes, Chattanooga, TN (US)

(21) Appl. No.: 18/756,657

(22) Filed: Jun. 27, 2024

(51) Int. Cl. F16L 55/172

(52) U.S. Cl. CPC F16L 55/172

(57) ABSTRACT

Provided herein is a clamping assembly comprising a plurality of clamping lugs, each of the clamping lugs defining a front end and a distal end, a first clamping lug of the plurality of clamping lugs configured to hingedly engage with an opposite second clamping lug of the plurality of clamping lugs at the distal ends of the first clamping lug and the second clamping lug and provide a range of open and closed positions, and a tightening mechanism which can be configured to urge the first and second clamping lug through the range of positions.

### TECHNICAL FIELD

### Field of Use

This disclosure relates to pipe clamps. More specifically, this disclosure relates to pipe clamp tightening mechanisms.

### Related Art

Numerous variations of repair clamps exist. These repair clamps are particularly useful for repairing generally cylindrical objects, such as pipes, that have sprung leaks, such as through cracks or holes. Typical pipes in need of repair are pipes in fluid systems, such as water utility, sewer, gas, or petroleum systems. In many cases, these repair clamps allow for pipes whose ends are inaccessible to be repaired, which would otherwise require line shutdowns, removal of end fittings, and/or highly invasive repair techniques. Such clamps often comprise a resilient band that wraps around the pipe, which can be sealingly tightened by a clamping assembly.

Because of the large variability of pipe types, materials, sizes, configurations, etc., it is difficult and costly to manufacture a pipe repair clamp for each of the aforementioned pipe configurations. Further, it presents a logistical challenge to stock and utilize an assortment of pipe repair clamps. In addition, pipe repair clamps are not manufactured in a manner which can be cheap and cost-effective.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a clamping assembly, the clamping assembly comprising a plurality of clamping lugs, each of the clamping lugs defining a frontal end and a distal end, a first clamping lug of the plurality of clamping lugs configured to hingedly engage with an opposite second clamping lug of the plurality of clamping lugs at the distal ends of the first clamping lug and the second clamping lug and provide a range of open and closed positions, and a tightening mechanism configured to move the first clamping lug towards the second clamping through the range of opened and closed positions.

In a further aspect, disclosed is a repair clamp assembly, the assembly comprising a curved flexibly resilient band extending in a circumferential direction relative to an axis extending through the band from a first end to a second end, the band defining an internal circumference therein, an elastomeric gasket disposed along the internal circumference of the curved flexibly resilient band; and a clamping assembly comprising a plurality of monolithic clamping lugs, each clamping lug defining a proximal end engaged with one of the first end and the second end of the flexibly resilient band and a distal end engaged with an opposite clamping lug of the plurality of clamping lugs to form a hinge, and a tightening mechanism configured to provide a clamping force to the plurality of clamping lugs.

In yet another aspect, disclosed is a method for manufacturing a clamping assembly, the method comprising the steps of forming a plurality of monolithic clamping lugs, providing a flexibly resilient band, wherein the band extends in a circumferential direction and comprises a first end and a second end, providing a tightening mechanism comprising a nut and an associated bolt, and joining the flexibly resilient band, tightening mechanism, and the plurality of clamping lugs.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the Figures may be designated by matching reference characters for the sake of consistency and clarity.

FIG. 1 is a perspective view of a pipe clamp repair device in accordance with one aspect of the current disclosure.

FIG. 2 is a cross-sectional view of the repair clamp device of FIG. 1.

FIG. 3 is a top perspective view of a clamping assembly of the pipe clamp repair device of FIG. 1 taken from detail 103 of FIG. 1.

FIG. 4 is an bottom perspective view of the clamping assembly of Figure in accordance with another aspect of the current disclosure.

FIG. 5 is a frontal view of the clamping assembly as shown in FIG. 3.

FIG. 6 is a rear view of the clamping assembly as shown in FIG. 3.

FIG. 7 is an isometric view of a pair of clamping lugs in accordance with one aspect of the current disclosure.

FIG. 8 is an isometric view of a clamping lug in accordance with one aspect of the present disclosure.

FIG. 9 is an bottom isometric view of the pair of clamping lugs as shown in FIG. 7 in accordance with one aspect of the present disclosure.

FIG. 10 is a perspective view of an alternative embodiment of the clamping lug of FIG. 8.

FIG. 11 is a frontal view of a tightening mechanism in accordance with one aspect of the present disclosure.

FIG. 12 is a perspective view of the elastomeric element of FIG. 1 in accordance with one aspect of the present disclosure.

FIG. 13 is a frontal perspective view of an alternate embodiment of a clamping lug in accordance with another aspect of the present disclosure.

FIG. 14 is a top perspective view of a spreader bar in accordance with one aspect of the present disclosure.

FIG. 15 is a frontal perspective view of an alternative embodiment of the repair clamp in accordance with yet another aspect of the present disclosure.

FIG. 16 is a frontal perspective view of a section of the tightening mechanism in accordance with yet another aspect of the present disclosure.

FIG. 17 is a frontal perspective view of the retention clip in accordance with one aspect of the present disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

In one aspect, a pipe repair clamp that offers a wide range of adaptability is provided. In one aspect, the pipe repair comprises a band clamp element which can be sizeably configured to engage the circumference of a pipe. The pipe repair clamp can include an elastomeric element disposed along an interior perimeter of the band clamp element which can be forced into engagement with the pipe by the band clamp element. The band clamp element can terminate into a clamping assembly which can comprise a plurality of clamping lugs in communication with a tightening mechanism. When urged by the tightening mechanism, the band clamp element can be constricted, thereby forcing the band clamp element to forcibly engage the pipe. The pipe repair clamp can be structured to secure and/or repair damage to a wide variety of pipes and can be applied to damaged pipe surfaces. In some aspects, the pipe repair clamp can be configured to engage a continuous pipe without necessitating first engaging the pipe repair clamp with a terminating end of the pipe. Further, the components of the pipe repair clamp can be adapted to be formed from mass manufacturing techniques.

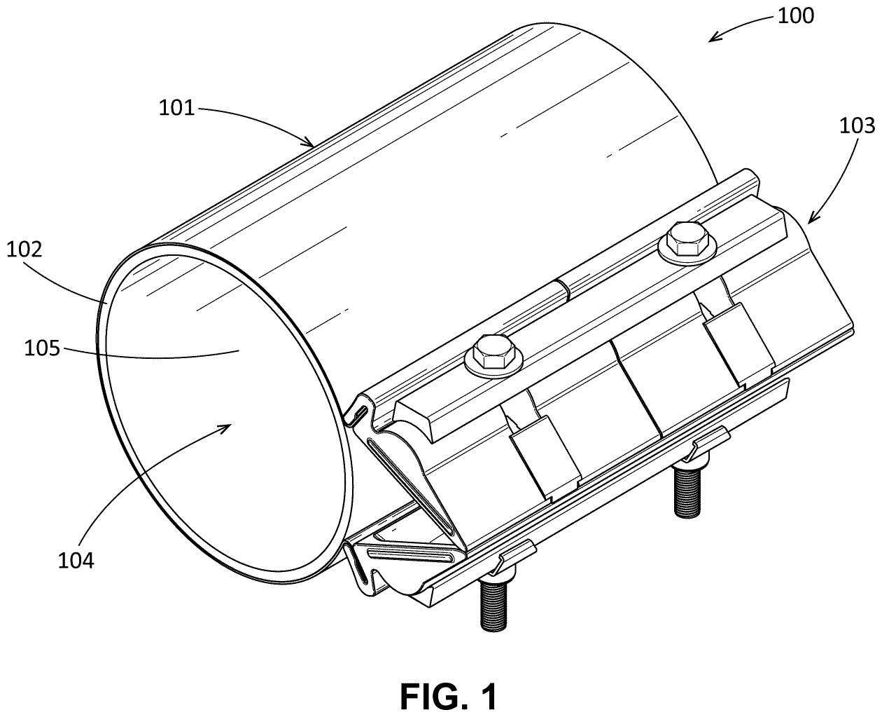

One aspect of a pipe repair clamp 100 is disclosed and described in FIG. 1. In such an aspect, the pipe repair clamp 100 comprises a repair band 101, which can be substantially cylindrical and sizably configured to engage with an outer surface of a pipe. In many aspects, the pipe repair clamp 100 can be configured to mechanically engage with damaged pipes. The repair band 101 can be constructed from a flexibly resilient material that has a suitable tensile strength to withstand deformation under a clamping force. In some aspects, the repair band 101 can be made of, for example and without limitation, sheet metal, polymeric sheets, or any rigid substantially planar material. The repair band 101 can be substantially hollow and can further define a sleeve 102 disposed about its interior surface. In some aspects, the sleeve 102 can be an elastomeric element, such as a polymer, a rubber, or a vinyl. The sleeve 102 can define a planar shape that can define a rolled state and an unrolled state, wherein the sleeve 102 is discontinuous when unrolled and continuous about a sleeve seam 105 when rolled. In some aspects, the sleeve seam 105 can be perpendicular to a face of the sleeve 102. In some aspects, the sleeve seam 105 can be diagonal to a face of the sleeve 102. The sleeve 102 can be configured to engage with the outer surface of the pipe, and optionally, when forcibly engaged therewith, provide a fluid-resistant seal. In some aspects, the sleeve 102 can be compressed, and while so compressed, adopt the profile of the pipe to provide a substantially fluid-resistant seal. In some aspects, the sleeve 102 can be configured with a non-linear profile which can sealably engage a damaged pipe. The pipe repair clamp 100 can define a cavity 104 which can be configured to receive an object. In an exemplary aspect, the cavity 104 can be configured to receive therethrough the pipe. In such as aspect, the cavity 104 can be sizeably configured to circumferentially engage with the outer surface of the pipe. In other aspects, the cavity can be structured to engage with a perimeter of an object. The pipe repair clamp 100 can also comprise a clamping assembly 103 which can be mechanically coupled with the repair band 101. The clamping assembly 103 can be configured to apply a clamping force to the repair band 101. In an exemplary aspect, the clamping assembly 103 can be configured to constrict the repair band 101 around an object, such as the pipe, and while so constricted, forcibly engage the sleeve 102 onto the outer surface of the pipe.

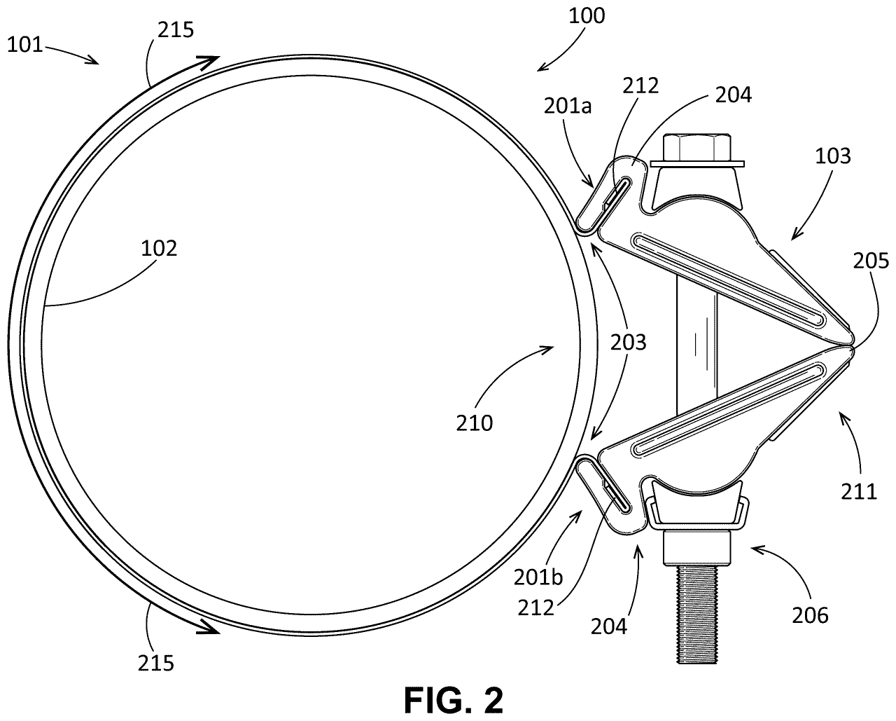

Turning now to FIG. 2, an end view of the pipe repair clamp 100 of FIG. 1 is provided. In some aspects, the repair band 101 can extend from a first band end 201a can terminate at a second band end 201b. Each of the first and second band ends 201a,201b can comprise a lip which can be folded over and configured to be received by the clamping assembly 103. In some aspects, the first band end 201a and/or second band end 201b can comprise a hem 212. In an exemplary aspect, each of the first and second band ends 201a, 201b can define a section which can be folded over about 180 degrees. In some aspects, each of the first and second band ends 201a, 201b can define a bend which can extended from each end outward from the repair band 101 which can comprise a folded over section which can define a thickness greater than a thickness of the repair band 101. In some aspects, the folded over section is a hem 212, wherein the thickness of the hem 212 is greater than the thickness of the repair band 101. In some aspects, the first band end 201a can comprise a hem 212 and the second band end 201b can comprise a hem 212.

In some aspects, the clamping assembly 103 can comprise a forward end 210 and a pivot end 211 opposite the forward end 210. In some aspects, the forward end 210 can be configured to engage with the repair band 101 at a band end joint 203. The forward end 210 can comprise one or more hem joints 204 which can each define, in some aspects, a substantially U-shaped formation which can receive therein a structure. The hem joints 204 can be formed at the forward end 210, for example at the band end joint 203. The hem joints 204 can be configured to receive the repair band 101, or a portion thereof. For example only, each hem joint 204 can be configured to receive a respective hem 212 of the first or second band end 201a, 201b, as further described below. In some aspects, the unity of a respective folded over section or hem 212 and a respective hem joint 204 can form a solid joint. In some aspects, the band end joint 203 is configured to secure the repair band 101 to the clamping assembly 103. The band end joint 203 can be configured to retain the repair band 101 to the clamping assembly 103 via, for example, an interference fit. It is envisioned that the combination of the hem 212 and the gap can be configured to form a secure fit.

The clamping assembly 103 can also define a fulcrum 205 disposed on the pivot end 211 of the clamping assembly 103. In some aspects, the clamping assembly 103 can be structured to articulate about the fulcrum 205. The clamping assembly 103 can further comprise a tightening mechanism 206 which can be operable to provide the compression force to the clamping assembly 103. In some aspects, the tightening mechanism 206 can be configured to engage with and optionally compress the clamping assembly 103. In some aspects, the tightening mechanism 206 can be configured to articulate the clamping assembly 103 about the fulcrum 205. The tightening mechanism 206 can be configured to modulate the clamping force and/or position of the tightening mechanism 206.

It is contemplated that the clamping assembly 103 can be arranged as a second class lever, wherein the clamping assembly 103 is the lever which articulates about the fulcrum 205 and applies a load to the repair band 101 with the tightening mechanism 206 at the band end joint 203. In some aspects, the clamping assembly 103 can define a range of positions about and between an opened position and a closed position. The tightening mechanism 206 can be configured to urge the clamping assembly 103 to actuate through a range of positions about and between open position and closed position. The clamping assembly 103, while engaged with the repair band 101 and moving through the range of open and closed positions, is operable to alter a circumference 215 of the repair band 101. For example only, the clamping assembly 103 can be articulated from an open position to a closed position, and simultaneously reduce the circumference 215 of the repair band 101. In another exemplary aspect, the tightening mechanism 206 can be engaged with the clamping assembly 103 via the band end joint 203 and can be operable to provide a tension force which can be transmitted to the repair band 101 via the band end joint 203. During such event, the tension to the repair band 101 can be increased and can forcibly constricted the repair band 101 around an object, such as a pipe, and forcibly engage the sleeve 102 therewith. It is envisioned that such an arrangement can be utilized to apply the clamping force around the outer circumferential surface of a pipe.

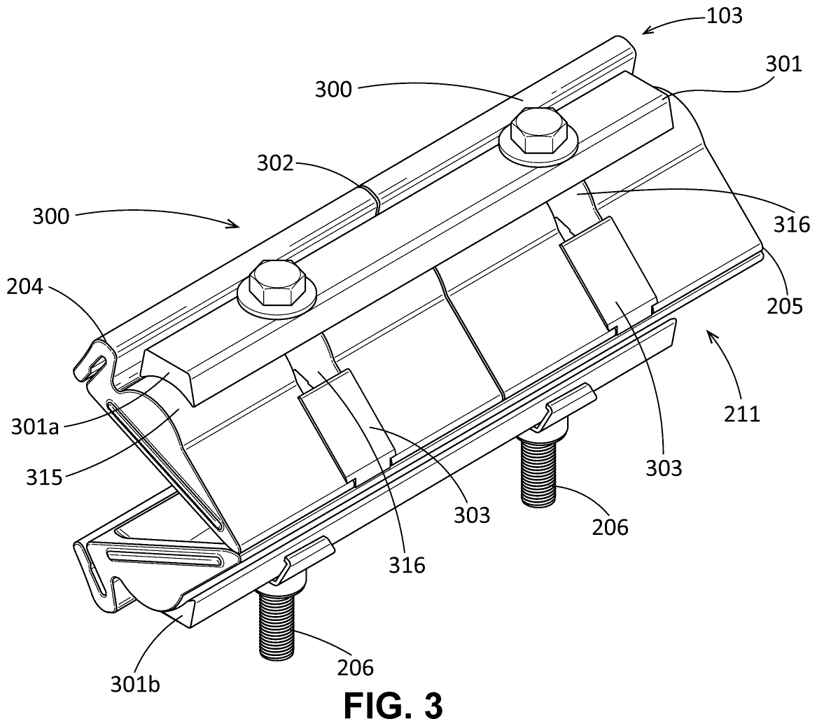

Consistent with FIG. 3, a top perspective view of the clamping assembly 103 of FIG. 1 is provided. The clamping assembly 103 can comprise one or more clamping lugs 300 optionally combined to form an assembled structure. In some aspects, the clamping assembly 103 can comprise a pair of clamping lugs 300 in hinged mechanical communication about the fulcrum 205. In some aspects, the clamping assembly 103 can comprise a pair of clamping lugs 300 coupled at lug joint 302. In some aspects, the lug joint 302 can be configured to laterally couple a pair of clamping lugs 300. In the present aspect, the clamping assembly 103 can further include the tightening mechanism 206 which can be configured to apply the compressive force to the clamping lugs 300. The tightening mechanism 206 can be in mechanical communication with the clamping lugs 300 via a spreader bar 301. In some aspects, the clamping assembly 103 can comprise a pair of spreader bars 301 which can be opposing one another. In some aspects, the spreader bars 301 can be configured to engage with a top surface 315 of the clamping lugs 300. In some aspects, the top surface 315 can be substantially arched or curved. In some aspects, the top surface 315 of the clamping lugs 300 can be configured to be structural load-bearing elements and dissipate a load. For example only, and without limitation, the spreader bars 301 can engage the top surface 315 of the clamping lug and substantially evenly distribute the compressive force from the tightening mechanism 206 about the top surface 315 of the clamping lug 300. Further, in some aspects, the spreader bars 301 can be configured to slide across the arched or curved top surface 315 during tightening of the tightening mechanism 206 as the clamping lugs 300 rotate about the fulcrum 205. The spreader bars 301 can be constructed from a substantially resilient material and structured to resists bending or deformation, such as a metal or polymer. The spreader bar 301 can be adapted to lower the pressure and/or stress from the clamping load provided by the tightening mechanism 206 substantially evenly across a surface, such as the top surface 315 of the clamping lug 300. Some aspects can comprise the hem joint 204 extending across an end of the clamping assembly 103, such as the forward end 210. The hem joint 204 can be adapted to engage with an external structure, such as a band clamp element or repair band 101. The clamping lugs 300 can comprise a slot 316 which can be defined by a voided area partially extending in a direction of the clamping lug 300. In some aspects, the slot 316 can begin at an intermediary location withing the clamping lug 300 and terminate at the pivot end 211. The slot 316 can be configured to receive the tightening mechanism 206. In some aspects, the clamping assembly 103 can include a retention clip 303. The retention clip 303 can be configured to engage with a portion of the clamping lug 300. In some aspects, the retention clip 303 can be received by the slot 316 formed in the clamping lug 300. In other aspects, the retention clip can be removably secured by the slot 316. In some aspects, the retention clip 303 can be configured to securely locate the tightening mechanism 206 within the slot 316.

In some aspects, the tightening mechanism 206 can extend perpendicularly or at an angle relative to the clamping assembly 103 through the slot 316 and engage the top surface 315 via the spreader bar 301. The spreader bar 301 can be configured to extend along the top surface 315 of the clamping lugs 300 and distribute the force from the tightening mechanism 206. In some aspects, a pair of spreader bars 301 is provided. In yet another aspect, a first spreader bar 301a is located on the top half of the clamping assembly 103 and a second spreader bar 301b is located on the bottom half of the clamping assembly 103. In some aspects, the spreader bar 301 can extend past the lug joint 302 and across one or more clamping lugs 300. In some aspects, the spreader bar 301 can be configured to join two clamping lugs 300 at the lug joint 302. In some aspects, the spreader bars 301 can be configured to retain the clamping lugs 300 at the lug joint 302 when exposed to a load.

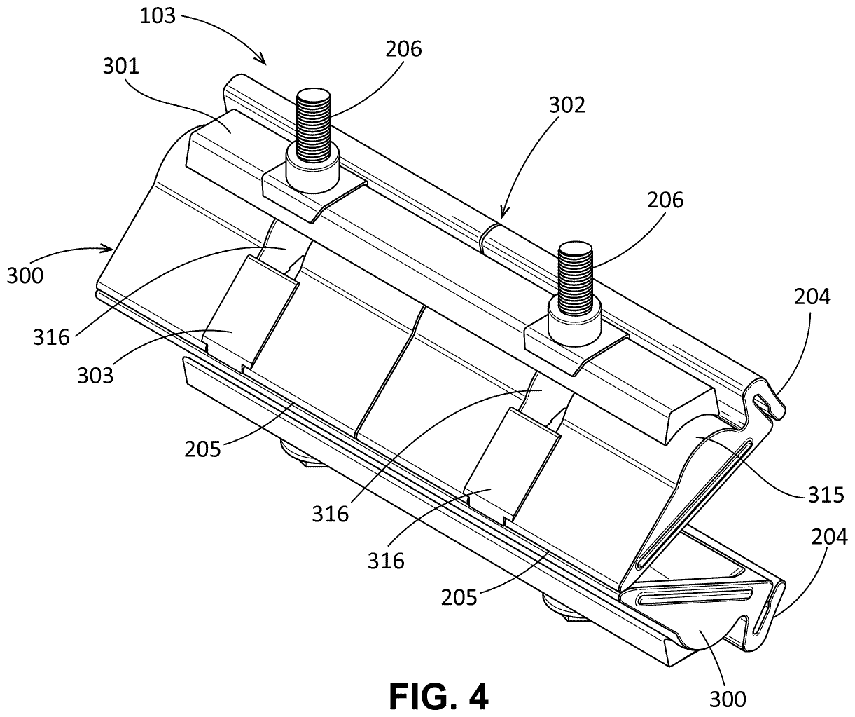

Consistent with FIG. 4, is a bottom perspective view of the clamping assembly 103 of FIG. 3 is shown. The clamping lugs 300 of the clamping assembly 103 can be laterally coupled or hingedly coupled. In some aspects, the clamping lugs 300 can be laterally coupled on a side thereof via the lug joint 302 and can be hingedly coupled via the fulcrum 205. In some aspects, the clamping assembly 103 can comprise two pairs of clamping lugs 300 both hingedly coupled and laterally coupled. In some aspects, when the clamping lugs 300 are coupled they can form an assembled structure. Moreover, it envisioned that the combination of multiple clamping lugs 300 can form an assembled structure, wherein the assembled structure can be a singular larger clamping lug 300 formed of the unity of one or more individual clamping lugs 300. In other aspects, a single monolithic clamping lug 300 can be formed rather than an assembled structure. The clamping assembly 103 can be configured to resemble a second order lever wherein the tightening mechanism 206 can be configured to provide an effort, wherein the clamping lugs 300 are configured to provide a clamping load, and wherein the fulcrum 205 forms the hinged fulcrum. It is envisioned that, in some aspects, a clamping assembly 103 can comprise one or more clamping lugs 300 in mechanical communication at one or more lug joints 302 to form a clamping assembly 103.

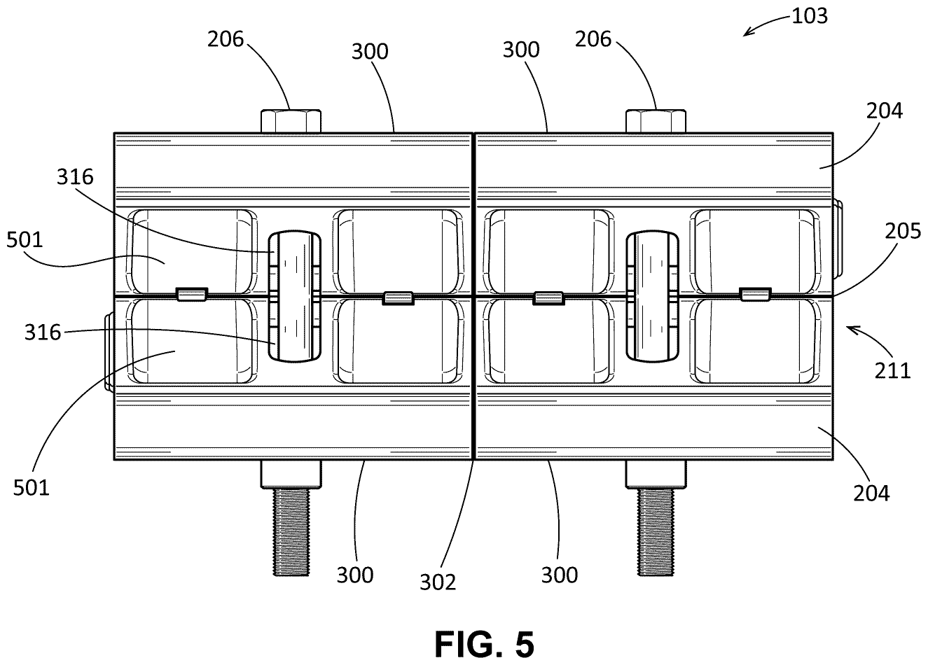

Turning now to FIG. 5, a frontal view of the clamping assembly 103 of FIG. 3 is shown. In some aspects, the tightening mechanism 206 can extend through the clamping assembly 103 via the slot 316 formed in the clamping lugs 300. In some aspects, the tightening mechanism 206 can intersect the clamping assembly 103 in a substantially central location. In some aspects, the tightening mechanism 206 can intersect the clamping assembly 103 at more than one location, for example only any without limitation, at two locations. In an exemplary aspect, a portion of the tightening mechanism 206 can be configured to extend perpendicularly through the clamping lugs 300. In the current configuration, the tightening mechanism 206 can be adapted to urge the clamping assembly 103 to move through the range of positions between open and closed about the fulcrum 205. Continuing with the current aspect, the clamping assembly 103 can comprise four clamping lugs 300 with respective pairs of clamping lugs 300 in mechanical communication at the lug joints 302 and forming a pair of assembled clamping lugs 300 hingedly connected at the fulcrum 205. Each of the two pairs of clamping lugs 300 are thereby in lateral communication with each other at the lug joints 302. In some aspects, the clamping lugs 300 can each comprise a lug cavity 501. The lug cavity 501 can comprise a void on an underside of the clamping lug 300. The lug cavity 501 can be disposed on an underside surface of the clamping lug 300, and on either side of the slot 316. The clamping lugs 300 can include one or more lug cavities 501. In some aspects, the lug cavity 501 can define a recessed structure on an underside of the clamping lug 300. In some aspects, the clamping lug 300 can comprise two lug cavities 501 which can be separated by the slot 316.

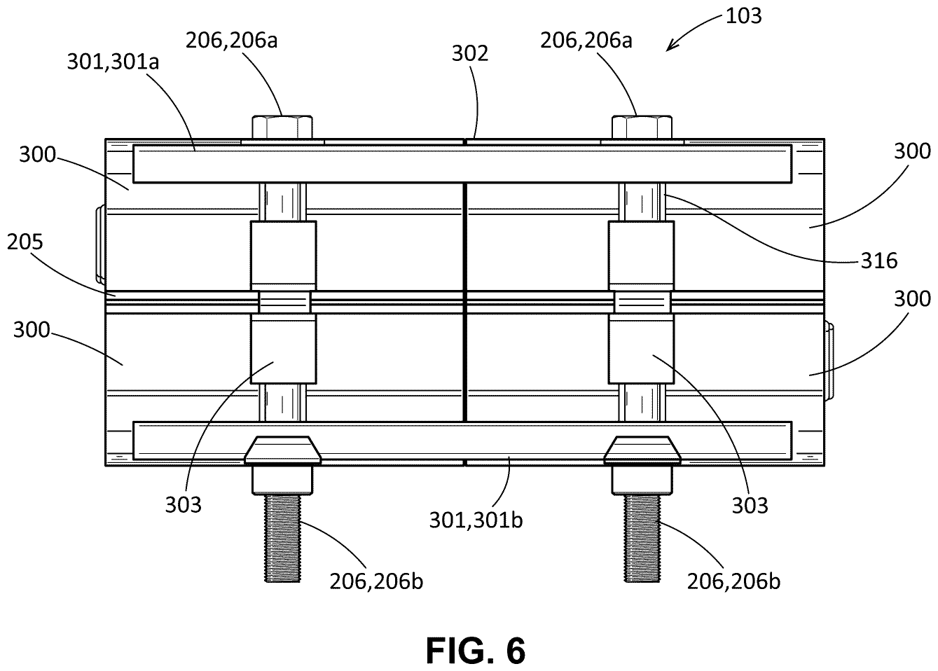

Turning now to FIG. 6, a rearward view of the clamping assembly 103 of FIG. 3 is provided. In one aspect, the clamping assembly 103 can comprise two pairs of hingedly connected clamping lugs 300 which can be in lateral mechanical communication at the lug joint 302 and form an assembled clamping assembly 103. The tightening mechanism 206 of the current aspect can define a proximal end 206a and a distal end 206b. In some aspects, the clamping assembly 103 can comprise the first spreader bar 301a in contact with the proximal end 206a of the tightening mechanism 206 and the second spreader bar 301b in contact with the distal end 206b of the tightening mechanism 206. The spreader bars 301 can extend across the top surface 315 of the clamping assembly 103 and provide substantially even tightening force to the clamping assembly 103.

In some aspects, the clamping assembly 103 can include a plurality of hingedly coupled clamping lugs 300. Moreover, it is envisioned that some aspects of the clamping assembly 103 can comprise more than two pairs of clamping lugs 300. In some aspects, the clamping assembly 103 can define a size which can be modular and configurable based on the number of pairs of clamping lugs 300 included and an overall length of the pipe clamp repair device 100. For example only, a pipe repair clamp 100 can be of varying length based on the number of clamping lugs 300 that are included. Further, the size of the clamping assembly 103 and/or pipe repair clamp 100 can depend on the number of pairs of clamping lugs 300 used. It is envisioned that a user can tailor the size of the pipe repair clamp 100 or clamping assembly 103 based on the specific requirements of the repair and optionally lengthen or shorten the size thereof based on the number of pair of clamping lugs 300 used. In some aspects, once the clamping lugs 300 are combined, they can form an assembled clamping assembly 103.

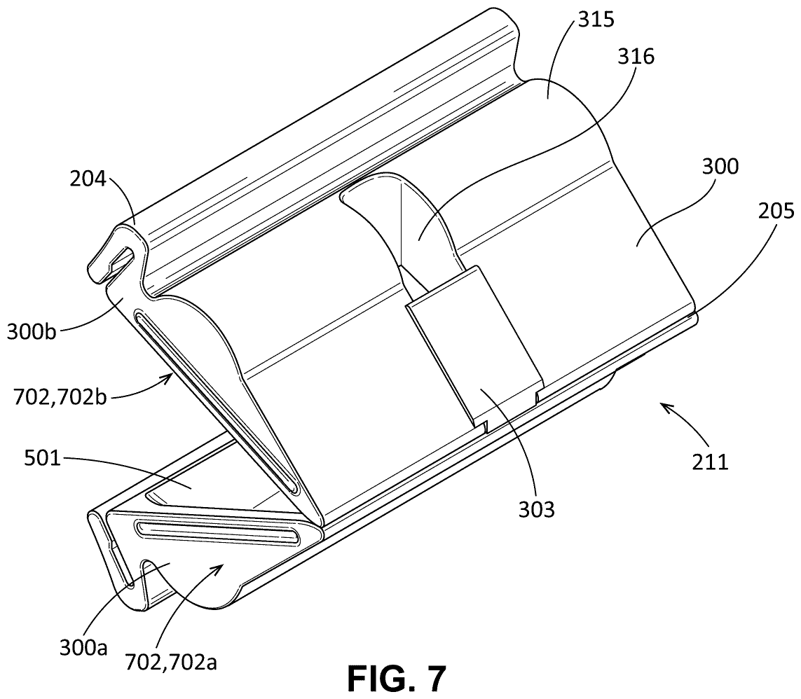

FIG. 7 illustrates a pair of clamping lugs 300 hingedly connected at the fulcrum 205.

The slot 316 can be configured to section the clamping lug 300 into one or more sections. In some aspects, the slot 316 can be configured to section the clamping lug 300 into two sections. In an example aspect is a retention clip 303 disposed in the slot 316. The retention clip 303 can be operable to secure the tightening mechanism 206 in the slot 316. In some aspects, the retention clip 303 can be formed of a polymeric material. In other aspects, the retention clip 303 can be an injection-molded plastic element. In an example aspect, the retention clip 303 can be received by the slot 316 via a snap-fit, press fit, button fit, finger lock fit, or the like. In some aspects, the clamping assembly 103 can comprise a single retention clip 303. In alternative aspects, the clamping assembly 103 can comprise a plurality of retention clips 303. In some aspects, the clamping lug 300 can comprise an interlock 702 feature. The interlock 702 can be operable to provide lateral mechanical communication between adjacent clamping lugs 300, for example, at the lug joint 302. In some aspects, the interlock 702 can be disposed on a side of the clamping lug 300. In some aspects, the clamping lug 300 can contain multiple interlocks 702. In an exemplary aspect, the clamping lug 300 can comprise a first side 300a and a second side 300b, wherein the first side 300a is opposite the second side 300b. In some aspects the first side 300a of the clamping lug 300 can be interlocked with the second side 300b of a second clamping lug 300. In some aspects, the lug joint 302 can comprise the first side 300a of a first clamping lug 300 interlocked with the second side 300b of a second clamping lug via the interlock 702.

In some aspects, the interlock 702 can comprise a snap fit. In some aspects, the interlock 702 can comprise a male/female interlock. In some aspects the interlock 702 can comprise a female interlock 702a and a male interlock 702b wherein the male interlock 702b can be configured to be received by the female interlock 702a. In some aspects, the interlock 702 can comprise a tongue and grove feature wherein the male interlock 702b can be configured as the tongue and the female interlock 702a can be configured as the groove. In some aspects, the interlock 702 can be a fastener, such as a threaded bolt. In other aspects, the interlock 702 can be a dowel pin joint. It is contemplated that the clamping lugs can contain a pair of interlocks 702 disposed about a lateral surface. In some aspects, the clamping lug 300 can comprise the female interlock 702a on the first side 300a and the male interlock 702b on the second side 300b which can be opposite the first side 300a. In some aspects, the interlock 702 can facilitate the formation of the lug joint 302 at the lateral side.

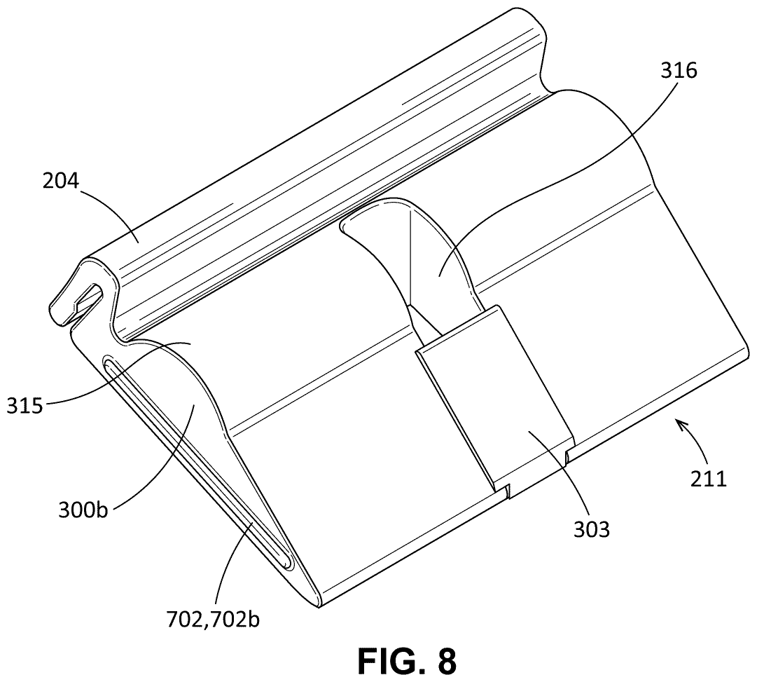

FIG. 8 provides a perspective view of a clamping lug 300 in accordance with another aspect of the present disclosure. In one aspect, the clamping lug 300 can comprise the slot 316 which can be adapted to receive the tightening mechanism 206. In some aspects, the retention clip 303 is disposed in the slot 316 and can be configured to secure the tightening mechanism 206 within the slot 316. The clamping lug 300 can comprise one or more interlock 702 features which can be adapted to form the lug joint 302 with additional clamping lugs 300. In some aspects, the clamping lugs 300 can be made from metal, such as cast or ductile iron, steel, aluminum, copper, magnesium, tin, brass, pewter, lead, a metal alloy, or any metal which can be cast. In other aspects, the clamping lugs 300 can be made of a polymer having suitable strength to bear a load, such as the clamping load. The clamping lug 300 can be formed from a variety of manufacturing processes which are suitable for forming solid parts such as machining, die casting, injection molding, stamping, extruding, additive manufacturing, and swaging. In some aspects, the clamping lug 300 can be adapted to be formed from a casting process, such as sand casting, investment casting, die casting, continuous casting, shell molding, or the like. In certain aspects, the clamping lugs are geometrically configured to be readily cast. In some aspects, the clamping lug 300 can be dimensioned for and to facilitate rapid casting or rapid manufacturing. In some aspects, the clamping lug 300 can be cast with a multiplicity of interlocks 702 about the surface of the clamping lug 300. In some aspects, the clamping lug 300 can be configured for mass manufacturing. The tightening mechanism 206 can be constructed from any metallic or polymeric material. The retention clip 303 can be constructed from a metallic or polymeric material.

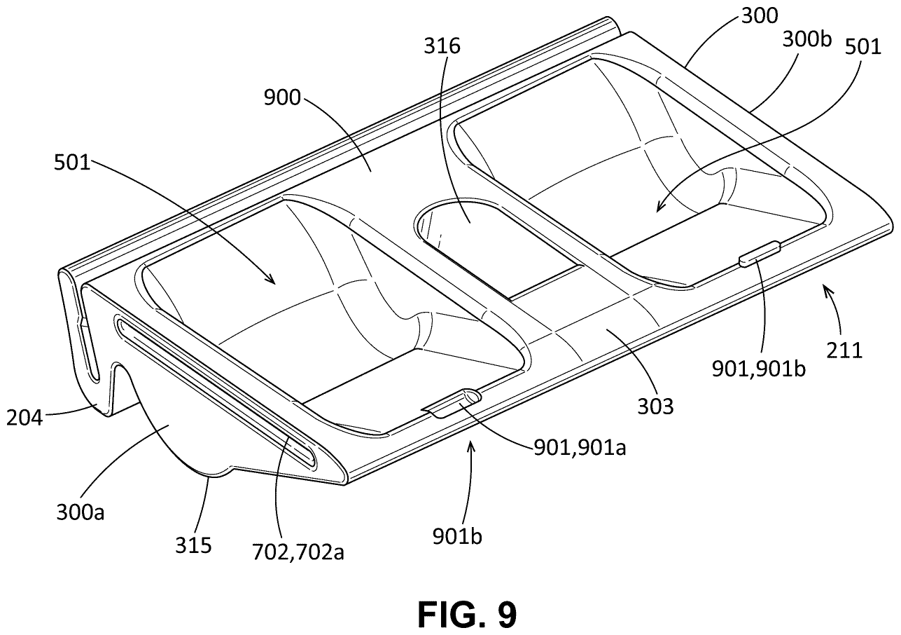

Shown in FIG. 9 is an alternative view of the clamping lug 300 of FIG. 8. More specifically, FIG. 9 depicts the opposite side and a bottom face 900 of the clamping lug 300 of FIG. 8. The cavities 501 on the clamping lug 300 can be disposed on either side of the slot 316. The cavities 501 formed in the clamping lug 300 can be adapted to facilitate a rapid and cost-efficient casting manufacturing process, requiring less material to cast each clamping lug 300. In some aspects, the clamping lug 300 can comprise a fulcrum lock 901 feature on the pivot end 211. In some aspects, the fulcrum lock 901 is operable to form the fulcrum 205 between a pair of clamping lugs 300 at the pivot end 211. For example only, a first clamping lug 300 can be mechanically coupled to a second clamping lug 300 at the pivot end 211 via the fulcrum lock 901. It is envisioned that the fulcrum lock 901 can establish hinged mechanical communication between a pair of clamping lugs 300 and provide a point about which the pair of claiming lugs 300 can articulate. In some aspects, the fulcrum lock 901 can comprise a snap fit. In some aspects, the fulcrum lock 901 can comprise a male/female interlock. In some aspects the fulcrum lock 901 can comprise a female fulcrum lock 901a and a male fulcrum lock 901b wherein the male fulcrum lock 901b can be configured to be received by the female fulcrum lock 901a. In some aspects, the fulcrum 205 can comprise a tongue and grove feature wherein the male fulcrum lock 901b can be configured as the tongue and the female fulcrum lock 901a can be configured as the groove. In some aspects, the fulcrum lock 901 can be a fastener, such as a threaded bolt. In some aspects, the fulcrum lock 901 can be a dowel pin joint. It is contemplated that the clamping lugs can contain a pair of fulcrum locks 901 at the pivot end 211. In some aspects, the clamping lug 300 can comprise a female fulcrum lock 901a on a first side 300a and a male fulcrum lock 901b on a second side 300b which can be opposite the first side 300a. In some aspects, the fulcrum lock 901 can facilitate the formation of and sustain the fulcrum 205 at the pivot side 211.

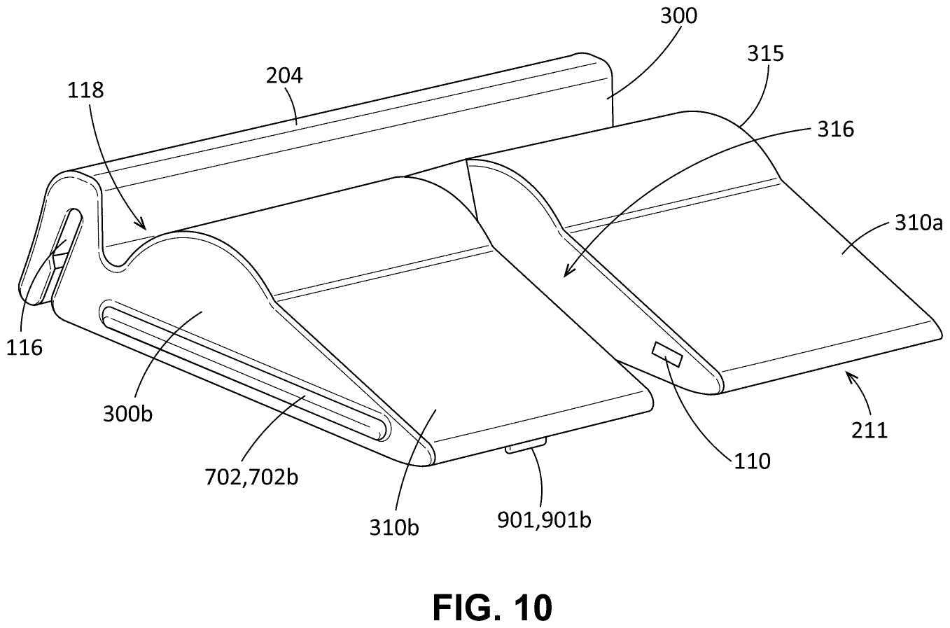

FIG. 10 shows an alternative aspect of the clamping lug of FIG. 8. One aspect of the disclosure includes a clamping lug 300 that comprises a body defining the slot 316 which can be formed in a substantially centered portion of the clamping lug 300. The clamping lug 300 can comprise a snap finger 110 feature disposed on an inner surface normal to the slot 316. The snap fit feature 110 can be configured to securably receive the retention clip 303. In some aspects, the snap finger 110 can comprise a slanted forward surface. It is envisioned that a user can combine the tightening mechanism 206 with the clamping lug 300 and, after combination, secure the tightening mechanism 206 to the clamping lug 103 with the retention clip 303. In some aspects, the retention clip 303 can be releasably secured in the slot 316 of the clamping lug via the snap finger 110. In some aspects, the retention clip 303 can be received by the clamping lug 300 via an interference fit. In some aspects, the slot 316 can separate the clamping lug 300 and define a first portion 310a and a second portion 310b. The first portion 310a can contain thereon one or more female interlock features 702a and/or one or more female fulcrum lock features 901a. The second portion 310a can contain thereon one or more male interlock features 702b and/or one more male fulcrum lock features 901b.

In some aspects, the clamping lug 300 can comprise a valley portion 118. The valley portion 118 can be disposed between the hem joint 204 and the top surface 315. The valley portion 118 can comprise a valley-shaped region which can be, in some aspects, curvilinear. In some aspects, the clamping lug 300 can comprise a hem void 116. The hem void 116 can be defined within the hem joint 204. The hem void 116 can be sized to engage with the hem 212 of the repair band 101. In some aspects, the hem void 116 can define a first portion and a second portion of varying widths, similar to the varying thicknesses of the hem 212. For example, as shown the hem void 116 can be wider towards an interior portion of the hem joint 204 and narrower at an exterior or exit portion of the hem void 116 that is proximate to the bottom face 900 of the clamping lug 300, in order to capture the hem 212 therein, with or without an interference fit. Further, in some aspects, as shown, the shape of the hem void 116 with open ends at the first side 300a and/or the second side 300b of the clamping lug 300 can allow the hem 212 to be slid into the hem void 116 laterally in aspects in which the hem void 116 is narrower at an exterior or exit portion of the hem void 116.

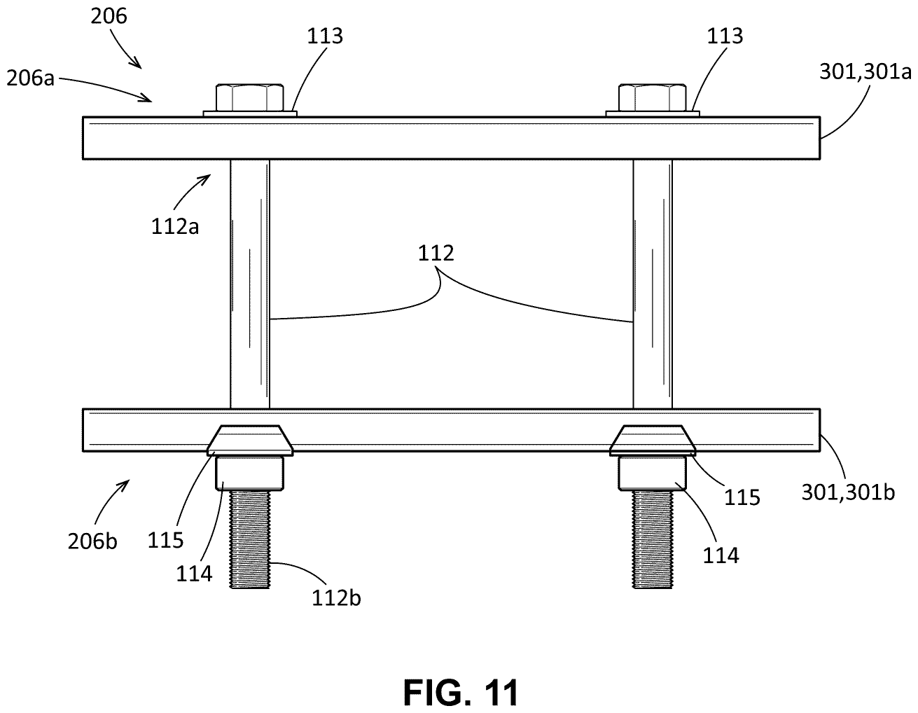

Turning now to FIG. 11, an exemplary aspect of the tightening mechanism 206 according to the present disclosure is shown. In one aspect, the tightening mechanism 206 can comprise one or more bolts 112 that extend in an axial direction perpendicular to the spreader bars 301. In some aspects, the bolts 112 can intersect the spreader bar 301 at about 90 degrees. In some aspects, the bolts 112 can be received by the spreader bar 301. In some aspects, the bolts 112 can define a bolt proximal end 112a and a bolt distal end 112b, wherein the bolt proximal end 112a comprises a bolt head and the bolt distal end 112b comprises a threaded portion. In an exemplary aspect, the bolts 112 are provided in a pair. In some aspects, the bolt proximal end 112a can comprise a washer 113. The bolt distal end 112b can comprise a nut 114, and a nut clip 115. The nut clip 115 can be a washer which can comprise a folded tab configured to engage with a side of the spreader bar 301. In some aspects, the nut clip 115 can engage more than one side of the spreader bar 301. The nut 114 can be configured to engage with the threaded portion of the bolt distal end 112b. In some aspects, the nut 114 can contact the nut clip 115. In one exemplary aspect, the nut 114 is threadedly received by the bolt 112 can be tightened against the nut clip 115. The tightening mechanism 206 can be operable to provide a compression force to the clamping assembly 103 through the manipulation of the nut 114. In one aspect, as the nut 114 is tightened onto the bolt 112, the distance between the first spreader bar 301a and the second spreader bar 301b of the tightening mechanism 206 can be decreased. The tightening mechanism 206, when manipulated, can articulate the clamping assembly 103 through a range of positions between open and closed.

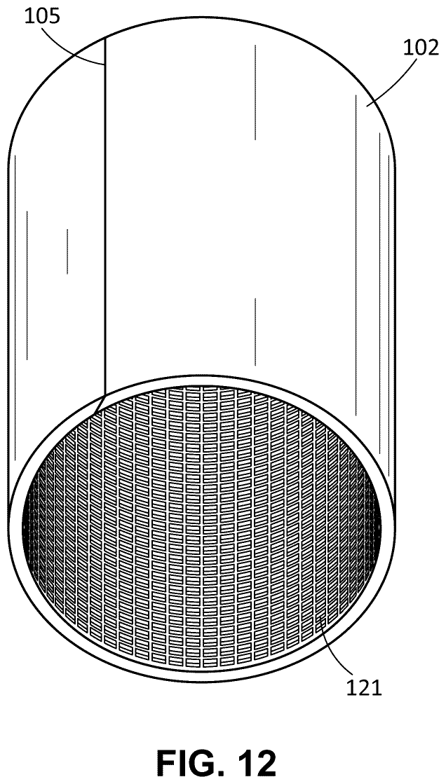

Turning now to FIG. 12, an isometric view of the sleeve 102 is provided. The sleeve 102 can be disposed about an interior perimeter of the repair band 101 and, while so disposed, define an extruded annular structure. In some aspects the sleeve 102 can be made of an elastomeric material, such as rubber, EPDM, Butyl, Styrene, butadiene, or neoprene or any thermoplastic elastomer such as polyurethane or an olefin. The sleeve 102 can be substantially elastic and configured to conform to a surface when forcibly pressed thereon. In some aspects, the sleeve 102 can be substantially flexible and deformable. In some aspects, the sleeve 102 can be substantially impermeable and resistant to any of heat, pressure, piercing, or shearing. In some aspects, the sleeve 102 can be sized to encircle an object, such as a pipe. In some aspects, the sleeve 102 can define an engagement surface 121 which can contain thereon a texture or pattern, such as a waffle pattern. In some aspects, the pattern or texture of the engagement surface 121 can be adapted to facilitate a seal between the sleeve 102 and an object, such as a pipe. The sleeve 102 can be discontinuous and terminates at the sleeve seam 105. In some aspects, the sleeve 102 can be sizably configured and applied to an internal circumference of the repair band 101. In an exemplary aspect, the sleeve 102 can be cut and wrapped around internal surface of the repair band 101 before use of the pipe repair clamp 100.

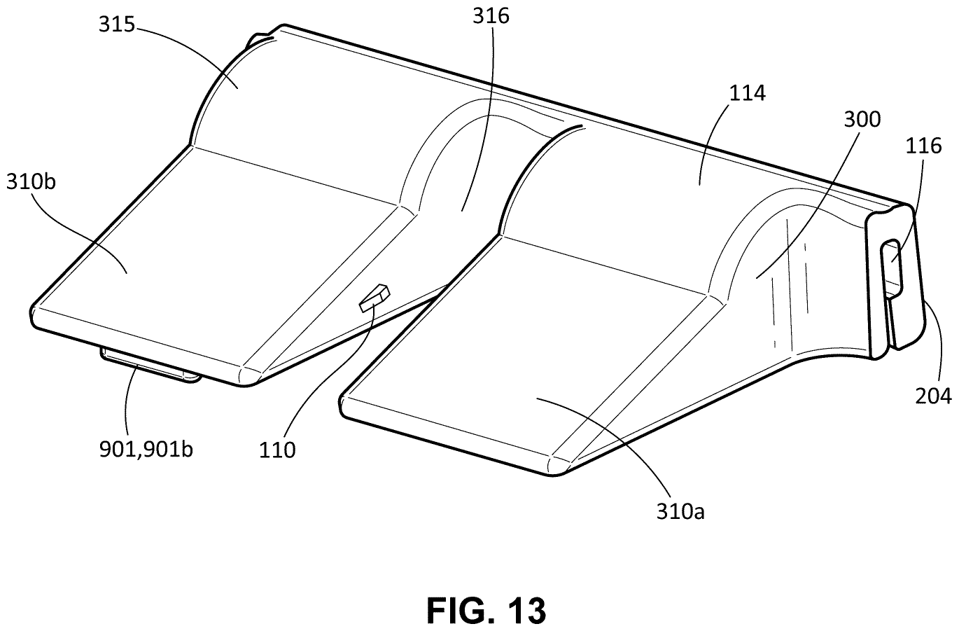

Turning now to FIG. 13, an isometric view of an alternate aspect of the clamping lug 300 is shown and described. In some aspects, the hem joint 204 can be located at an end of the clamping lug 300. The hem joint 204 can define the hem void 116 which can define a slot configured to receive an edge, for example the hem 212. In some aspects, the clamping lug 300 can comprise the snap fit 110 disposed on an inner surface normal to the slot 316. In some aspects, the snap finger 110 can be configured to retain an item, such as a retention clip 303. The snap fit 110 can be configured to releasably retain the retention clip 303.

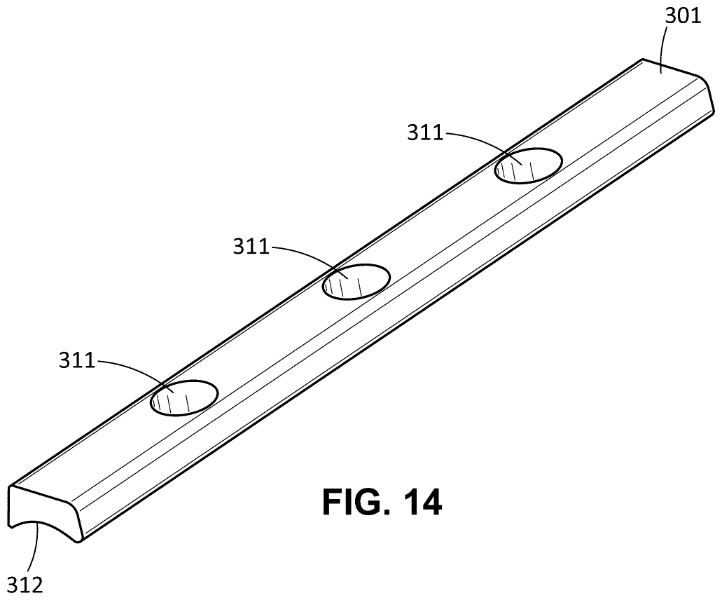

Turning now to FIG. 14, an isometric view of a spreader bar 301 is shown and described. The spreader bar 301 can be an elongated member which can be substantially rigid and configured to distribute a load. In some aspects, the spreader bar is a metallic or metalloid. In some aspects, the spreader bar 301 can comprise one or more holes 311 disposed along the length of the spreader bar 301. The holes 311 can be sized to receive the bolt 112 and more generally, receive the tightening mechanism 206. In some aspects, the spreader bar 301 can comprise a curved lower surface 312 which can be configured to engage the top surface 315 of the clamping lug 300, as previously described.

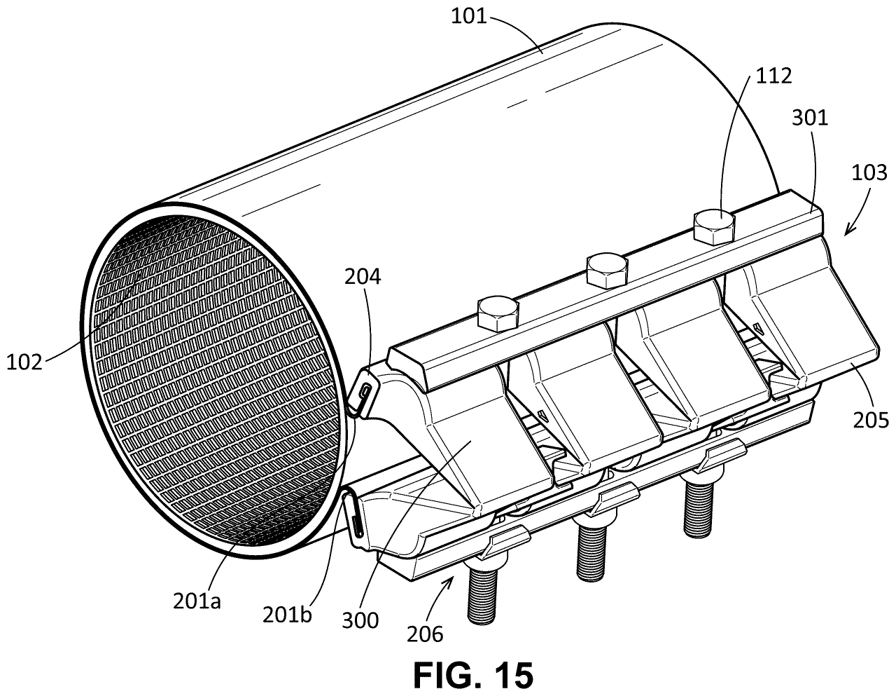

Turning now to FIG. 15, an assembly view of a pipe repair clamp 100 in accordance with another aspect of the present disclosure is shown and described. The pipe repair clamp 100 can comprise a plurality of clamping lugs 300 which can be joined together to form an assembled structure. In some aspects, the clamping lugs 300 can be joined together via the spreader bar 301. The spreader bar 301 can be configured to span across multiple clamping lugs 300 and engage with each clamping lug 300 to form an assembled structure. In some aspects, the length of the spreader bars 301 and the number of clamping lugs 300 used can be modulated based on the size of pipe repair clamp 100 required. In some aspects, the spreader bar 301 is operable to provide a retentive force which can combine multiple clamping lugs 300.

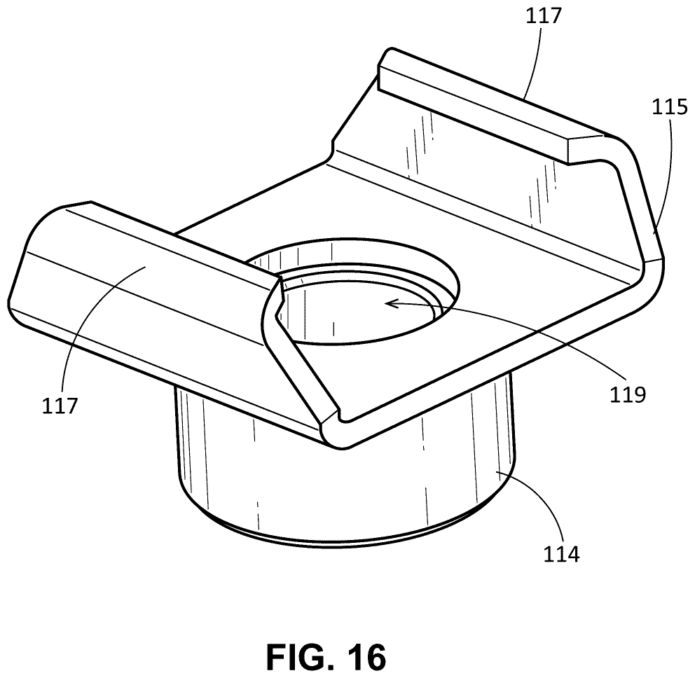

Turning now to FIG. 16, a lower portion of the tightening mechanism 206 is shown and described. The lower portion of the tightening mechanism 206 can comprise the nut 114. The nut can be structured to engage the bolt 112. The nut 114 can begin engagement with the bolt 112 at the bolt proximal end 112b. The nut 114 can threadedly translate across the length of the bolt 112. In some aspects, the nut 114 is threadedly engaged with the bolt 112. The bolt 112 can comprise a structure that is configured to engage with a fastening tool, such as a socket, a wrench, or even manual or hand engagement by a user. The lower portion of the tightening mechanism 206 can comprise the nut clip 115. The nut clip 115 can contact the nut 114 and can be urged to translate down the length of the bolt 112 by the nut 114. In some aspects, the nut clip 115 can comprise one or more hook sections 117. The hook sections 117 can be configured to engage the tightening mechanism 206. In some aspects, the hook sections 117 can securably engage with the spreader bar 301. In some aspects, the hook sections 117 can be structured to interlock with the spreader bar 301. For example only, the hook sections 117 can each comprise a profile which can engage with at least one side of the spreader bar 301. In such an example, the nut clip 115 can slidably engage with an end of the spreader bar 301 and be translated down a length of the spreader bar 301. In some aspects, the nut clip 115 can comprise a through hole 119. The through hole can be disposed substantially centrally in the nut clip 115. The through hole 119 can be configured to receive the bolt 112.

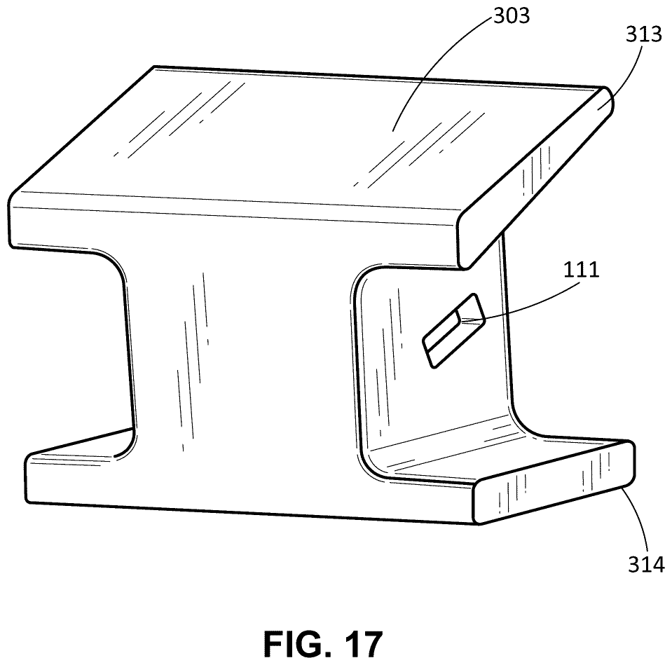

Turning now to FIG. 17, an aspect of the retention clip 300 is shown and described. The retention clip 303 can be configured to engage with the clamping lug 300. More specifically, the retention clip 303 can be configured to engage with the clamping lug 300 via the slot 316. The retention clip 303 can comprise a profile which can be received by the slot 316. In some aspects the retention clip 303 can be formed to engage more than one surface on the clamping lug 300. In some aspects, the retention clip 303 can comprise a top flange 313 and a bottom flange 314. In one aspect, the top flange 313 and the bottom flange 314 can be parallel. In some aspects, the top flange 313 can be disposed at an angle relative to the bottom flange 314. In some aspects, the top flange 313 and/or bottom flange 314 can be configured to engage with a surface of the clamping lug 300. The retention clip 303 can be configured to provide a holding force to the tightening mechanism 206. For example only, and without limitation, the bolt 112 of the tightening mechanism 206 can be inserted into the slot 316 of the clamping lug 300. The retention clip 303 can be inserted into the slot 316 and securably retain the bolt 112 of the tightening mechanism 206. In some aspects, the retention clip 303 can comprise one or more snap indents 111. Each snap indent 111 can comprise a recessed section formed in a side of the retention clip 303. In some aspects, a snap indent 111 can be formed on each side of the retention clip 303. Each snap indent 111 can be configured to mechanically engage with a respective snap finger 110 on a one of the clamping lugs 300. The snap indent 111 can be configured to engage with the snap finger 110 of the clamping lug 300 and form a snap fit interlock. In other aspects, the snap indent 111 can instead be formed on the clamping lug 300 and the snap finger 110 can be formed on the retention clip 303. In some aspects, the retention mechanism 303 can be formed from a polymer. For example only, and without limitation, the retention mechanism 303 can be formed from Acrylonitrile Butadiene Styrene (ABS), Polypropylene (PP), Polyethylene (PE),

Polycarbonate (PC), Polyethylene Terephthalate (PET), Polyoxymethylene (POM), Polyvinyl Chloride (PVC), Nylon (Polyamide), Polystyrene (PS), Polyurethane (PU), or the like. In some aspects, the retention mechanism 303 is formed by injection molding, 3-D printing, die cast molding, or the like.

A method for using the pipe repair claim 100 or any portion thereof can comprise providing the pipe repair clamp 100 or any portion thereof as disclosed herein. The method can comprise identifying a length to assemble the pipe repair clamp 100 and arranging the appropriate length repair band 101 and or sleeve 102. In some aspects, the method can comprise interlocking one or more clamping lugs 300 at a lateral lug joint 302. The method can comprise interlocking one or more clamping lugs 300 at a fulcrum 205. In some aspects, the method can comprise providing a tightening mechanism 206. The method can comprise tightening the tightening mechanism 206. In some aspects, the method can comprise configuring the pipe repair clamp 100 based on a required length. In some aspects, the method can comprise configuring the dimensions of the pipe repair clamp 100. In some aspects, the method can comprise assembling the clamping lugs 300 into an assembled structure. In some aspects, the method can comprise installing the tightening mechanism 206 between a clamping lug 300. In some aspects, the method can comprise installing a retention clip 303. In some aspects, the method can comprise retaining the tightening mechanism 206 with the retention clip 303. In some aspects, the method can comprise engaging the retention clip 303 with the clamping lug 300 via a snap fit.

The method can comprise forming at least one clamping lug 300. In some aspects the method of use can comprise casting at least one clamping lug 300 through a casting procedure. In some aspects, the method can comprise constricting the sleeve 102 around a pipe. In some aspects, the method can comprise the steps of tightening the clamping assembly 103 via the tightening mechanism 206 and forcibly constricting the sleeve 102 around a surface via the repair band 101. In some aspects, the method can comprise configuring the size of any of the clamping assembly 103, sleeve 102, repair band, or pipe repair clamp 100. In some aspects, the method can comprise forming the retention clip 303 from injection molding.

One should note that conditional language, such as, among others, “can,” “could,” “might,” or “may,” unless expressly stated otherwise, or otherwise understood within the context as used, is generally intended to convey that certain aspects include, while other aspects do not include, certain features, elements, and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

That which is claimed is:

1. A clamping assembly, the clamping assembly comprising:
a plurality of clamping lugs, each of the clamping lugs defining a frontal end and a distal end, a first clamping lug of the plurality of clamping lugs configured to hingedly engage with an opposite second clamping lug of the plurality of clamping lugs at the distal ends of the first clamping lug and the second clamping lug and provide a range of open and closed positions; and
a tightening mechanism configured to move the first clamping lug towards the second clamping through the range of opened and closed positions.

2. The clamping assembly of claim 1, wherein each of the plurality of clamping lugs further comprises a body that contains thereon an interlock operable to engage with adjacent clamping lugs.

3. The clamping assembly of claim 2, wherein the interlocks comprise male/female interlocks.

4. The clamping assembly of claim 2, wherein the interlock comprises a tongue and a groove, the tongue disposed on a first lateral side of each clamping lug and the groove disposed on a second opposite lateral side of each clamping lug.

5. The clamping assembly of claim 1, wherein each frontal end of each of the plurality of clamping lugs further comprises a folded-over hem configured to engage with an external clamp.

6. The clamping assembly of claim 1, wherein each of the plurality of clamping lugs further defines a slit sizeably configured to receive therethrough the tightening mechanism.

7. The clamping assembly of claim 6, further comprising a polymeric retention element disposed in the slit and adapted to retain the tightening mechanism.

8. The clamping assembly of claim 1, wherein each of the plurality of clamping lugs comprises a body that defines an interior surface which can be substantially concave and forms a void.

9. The clamping assembly of claim 1, wherein each of the plurality of clamping lugs further defines a rounded top surface.

10. The clamping assembly of claim 1, wherein each distal end of each of the plurality of clamping lugs further comprises a tongue and a groove configured to form a fulcrum when engaged with an opposite clamping lug.

11. The clamping assembly of claim 1, wherein the tightening mechanism comprises a threaded bolt, an associated nut, and a first and a second spreader bars, the first spreader bar engaging the first clamping lug and a second spreader bar engaging the second opposite clamping lug.

12. The clamping assembly of claim 11, wherein the tightening mechanism further comprises a nut retaining clip disposed on the bolt and adapted to secure the nut.

13. The clamping assembly of claim 11, wherein the first spreader bar extends perpendicular to the bolt and engages with the top surface of the first clamping lug and the second spreader bar extends perpendicular to the bolt and engages with the top surface of the opposite second clamping lug, the spreader bars are configured to distribute a clamping force provided from the bolt and nut across the first and second clamping lugs.

14. The clamping assembly of claim 1, wherein the tightening mechanism is operable to provide a clamping force to the first clamping lug and the opposite second clamping lug and forcibly urge the first clamping lug and the opposite second clamping lug to articulate throughout the range of open and closed positions.

15. The clamping assembly of claim 1, wherein the clamping assembly can be configured to provide a clamping force to an external structure.

16. A repair clamp assembly, the assembly comprising:
a curved flexibly resilient band extending in a circumferential direction relative to an axis extending through the band from a first end to a second end, the band defining an internal circumference therein;
an elastomeric gasket disposed along the internal circumference of the curved flexibly resilient band; and
a clamping assembly comprising:
a plurality of monolithic clamping lugs, each clamping lug defining a proximal end engaged with one of the first end and the second end of the flexibly resilient band and a distal end engaged with an opposite clamping lug of the plurality of clamping lugs to form a hinge; and
a tightening mechanism configured to provide a clamping force to the plurality of clamping lugs.

17. The repair clamp device of claim 16, wherein the first end and the second end of the flexibly resilient band each comprise a lip which can be received by a hem formed on the proximal end of one of the clamping lugs of the plurality of clamping lugs.

18. The repair clamp device of claim 16, wherein the tightening mechanism comprises a bolt, an anti-rotation clip, and a pair of spreader bars.

19. The repair clamp device of claim 16, wherein the distal end of the plurality of clamping lugs comprises a tongue and a grove.

20. The repair clamp device of claim 16, wherein the plurality of clamping lugs comprises a first clamping lug hingedly engaging an opposite second clamping lug at the distal ends and a third clamping lug hingedly engaging a fourth opposite clamping lug at the distal end, the first and second clamping lugs engage the third and fourth clamping lugs at a lateral interface.

21. The repair clamp device of claim 16, wherein the lateral interface of clamping lugs comprises a tongue and a grove feature.

22. The repair clamp device of claim 16, wherein the tightening mechanism comprises a bolt and associated nut, nut retaining clip, and a pair of spreader bars.

23. A method for manufacturing a clamping assembly, the method comprising the steps of:
forming a plurality of monolithic clamping lugs;
providing a flexibly resilient band, wherein the band extends in a circumferential direction and comprises a first end and a second end;
providing a tightening mechanism comprising a nut and an associated bolt; and
joining the flexibly resilient band, tightening mechanism, and the plurality of clamping lugs.

24. The method of claim 23, wherein forming the plurality of monolithic clamping lugs comprises casting the plurality of monolithic casting lugs.

25. The method of claim 24, wherein casting the plurality of monolithic clamping lugs comprises any one of: an injection molding process, a die casting process, a stamping process, an investment casting process, and an additive manufacturing process.

26. The method of claim 23, wherein the clamping assembly, when urged by a clamping force provided by the tightening mechanism, can be configured to forcibly constrict the flexibly resilient band.

27. The method of claim 23, wherein the tightening mechanism further comprises a pair of spreader bars configured to distribute the clamping force provided by the tightening mechanism.
